(19) United States
(12) Patent Application Publication
(10) Pub. No.: US 2026/0101161 A1
(43) Pub. Date: Apr. 9, 2026

(54) INTERNODE DIGITAL TWIN COLLABORATION

(71) Applicant: Dell Products L.P., Round Rock, TX (US)

(72) Inventors: Mohammad Alavirad, Kanata (CA); Said Tabet, Austin, TX (US); Ali Esswie, Calgary (CA)

(21) Appl. No.: 18/911,008

(22) Filed: Oct. 9, 2024

(51) Int. Cl. H04W 4/50; H04L 67/1095; H04W 24/02

(52) U.S. Cl. CPC H04W 4/50; H04L 67/1095; H04W 24/02

(57) ABSTRACT

Digital twin model classes may be defined that correspond to, or are indicative of, a model function or an entity function corresponding to a physical entity associated with a digital twin model. Model node outcomes based on parameter metrics associated with, or determined with respect to, physical entities may be requested by a central computing system associated with a central digital twin model node and may be reported to the central node by one or more distributed digital twin model node(s) corresponding to the entities. One or more digital twin model outcome(s) may be determined locally by one or more distributed digital twin nodes based on parameter value metrics, measured at distributed entities corresponding to the distributed nodes and may be reported to the central computing system.

### BACKGROUND

The ‘New Radio’ (NR) terminology that is associated with fifth generation mobile wireless communication systems (“G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption. A NR RAN node may comprise a Distributed Unit (“DU”), a Centralized Unit (“CU”), or a Radio Unit (“RU”). One or more of a DU, CU, and RU may be collocated or may be located at one or more different locations.

The terminology ‘digital twin’ (“DT”) may refer to a digital replica, or model, that may mimic a physical entity, a process, or a system and may be used to simulate, analyze, or optimize performance of the physical entity, process, or system in real time. Digital twin technology has been used in various fields including aerospace, manufacturing, healthcare, urban planning, and production, transmission, and delivery of energy. The National Aeronautical and Space Administration (“NASA”) did early development work with respect to digital twin technology to improve maintenance and operation of spacecraft, wherein physical entities and systems were digitally mirrored/mimicked to monitor and predict behavior of the entities and systems while operating during space missions, thus enhancing the ability to simulate operation of system in a space environment and the ability to troubleshoot and optimize systems remotely while an entity or system is actually operating in a space environment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by at least one computing system comprising at least one processor configured to execute at least one central model, directing, to at least one distributed entity corresponding to at least one distributed entity model, at least one available capability request. Responsive to the at least one available capability request, the method may further comprise facilitating, by the at least one computing system, receiving at least one available capability indication indicative of at least one available capability corresponding to the at least one distributed entity model. Based on the at least one available capability indication, the method may further comprise determining, by the at least one computing system, at least one function to delegate from the at least one central model to the at least one delegated entity to result in at least one determined function and delegating, by the at least one computing system, the at least one determined function to the at least one distributed entity to result in at least one delegated function.

In an example embodiment, the at least one computing system may comprise a first computing system executing the at least one central model. The at least one computing system may comprise a second computing system configured to execute the at least one distributed entity model.

In an example embodiment, the at least one computing system may comprise a first computing system. A second computing system that is different than the first computing system may be configured to execute the at least one distributed entity model. A radio network node corresponding to a radio access network may comprise the first computing system and a user device, for example a smart phone, a vehicle telematics control unit, a wireless hot spot, or a personal computer, communicatively coupled with the radio network node, may comprise the second computing system.

In an example embodiment, the at least one available capability indication may be indicative of at least one distributed entity model function corresponding to the at least one distributed entity model. The at least one delegated function may be at least one of the at least one distributed entity model function. The at least one distributed entity model function comprises at least one of: at least one energy efficiency function, at least one load/utilization function, at least one fault detection function, at least one capability function indicative of at least one function associated with the at least one distributed entity, or at least one radio link function. In an example embodiment, the at least one central model may comprise at least one central digital twin model. The at least one central digital twin model corresponds to the at least one distributed entity.

In an example embodiment, the at least one distributed entity model may comprise at least one distributed entity digital twin model.

In an example embodiment, the method may further comprise facilitating, by the least one computing system, directing, to the at least one distributed entity, distributed entity model configuration information comprising at least one distributed entity model function to be implemented by the at least one distributed entity. The distributed entity model configuration information may further comprise at least one parameter indication indicative of at least one parameter associated with the at least one distributed entity model function. The distributed entity model configuration information may further comprise at least one reporting criterion associated with the at least one distributed entity model function and may be usable by the at least one distributed entity to determine to direct, to the central model, the at least one available capability indication indicative of at least one available capability corresponding to the at least one distributed entity model. The at least one reporting criterion ma comprise a confidence level corresponding to an operation corresponding to the at least one distributed entity model function.

In another example embodiment, a computing system may comprise at least one processor configured to process executable instructions that, when executed by the at least one processor, may facilitate performance of operations that may comprise executing a first entity model and directing, to at least one distributed entity, at least one available model function class request. Responsive to the at least one available model function class request, the operations may further comprise receiving, from the at least one distributed entity, at least one available model function class indication indicative of at least one available model function class associated with at least one second entity model corresponding to the at least one distributed entity. Based on the at least one available model function class indication, the operations may further comprise determining at least one function corresponding to the first entity model to delegate to the at least one delegated entity to result in at least one delegated function to be facilitated by the at least one second entity model. The operations may further comprise directing, to the at least one distributed entity, at least one delegated function indication indicative of the at least one delegated function. Responsive to the at least one delegated function indication, the operations may further comprise receiving, from the at least one distributed entity, delegated function information corresponding to the at least one delegated function. Based on the delegated function information, the operations may further comprise directing operation of at least one computing resource corresponding to the at least one distributed entity.

The at least one computing resource may comprise at least one of: at least one processing resource, at least one storage resource, at least one radio channel resource, at least one memory resource, at least one power supply resource corresponding to the at least one distributed entity, or at least one battery resource corresponding to the at least one distributed entity.

In an example embodiment, the operations may further comprise directing, to the at least one distributed entity, distributed entity model configuration information indicative of the at least one available model function class and indicative of at least one reporting criterion associated with the at least one model function class. The at least one available model function class indication may be determined by the at least one distributed entity according to at least one distributed computing resource being determined to satisfy the at least one reporting criterion.

In yet another example embodiment, a non-transitory machine-readable medium may comprise executable instructions that, when executed by at least one processor of a computing system, may facilitate performance of operations that may comprise executing a first digital twin corresponding to a distributed entity, communicating, to the distributed entity, distributed digital twin configuration information indicative of at least one distributed digital twin function class and indicative of at least one reporting criterion associated with the at least one distributed digital twin function class, and communicating, to the distributed entity, at least one available function class request that requests reporting, by the distributed entity based on the at least one reporting criterion, of at least one available function class that is capable of being facilitated by the distributed entity. Responsive to the communicating the at least one available function class request to the distributed entity, the operations may further comprise receiving, from the distributed entity, at least one available model function class indication indicative of at least one available function class associated with a second digital twin corresponding to the distributed entity. Based on the at least one available model class indication, the operations may further comprise determining at least one function corresponding to the first digital twin to delegate to the at least one delegated entity to result in at least one determined delegated function to be facilitated by the second digital twin. The operations may further comprise communicating, to the distributed entity, at least one delegated function indication indicative of the at least one determined delegated function. Responsive to the communicating the at least one delegated function indication to the distributed entity, the operations may further comprise receiving, from the distributed entity, delegated function information corresponding to the at least one delegated function. Based on the delegated function information, the operations may further comprise activating at least one computing resource with respect to the distributed entity.

In an example embodiment, the computing system may comprise the distributed entity and the at least one computing resource.

In an example embodiment, the at least one available model function class indication may be determined by the distributed entity according to the at least one reporting criterion.

### BRIEF DESCRIPTION OF THE DRAWINGS

FIG. 1 illustrates an example environment with digital twin functionality being delegated from a central digital twin to a distributed digital twin corresponding to a distributed entity.

FIG. 2 illustrates example distributed entity model configuration information.

FIG. 3 illustrates an example available capability indication indicative of at least one available capability corresponding to a distributed entity digital twin model.

FIG. 4 illustrates an example delegated function indication indicative of a delegated function.

FIG. 5 illustrates example delegated function information corresponding to a delegated function.

FIG. 6 illustrates a timing diagram of delegation of at least one digital twin function from a central digital twin model to a distributed digital twin model.

FIG. 7 illustrates a block diagram of an example method embodiment.

FIG. 8 illustrates a block diagram of an example radio access network node.

FIG. 9 illustrates a block diagram of an example non-transitory machine-readable medium embodiment.

FIG. 10 illustrates an example computer environment.

FIG. 11A illustrates an example vehicle with distributed digital twin models performing delegated functions to facilitate a central digital twin at a server.

FIG. 11B illustrates an example vehicle with distributed digital twin models performing delegated functions and a master vehicle digital twin model to facilitate a central digital twin at a server.

FIG. 12A illustrates an example computing device with distributed digital twin models performing delegated functions to facilitate a central digital twin at a server.

FIG. 12B illustrates an example computing device with distributed digital twin models performing delegated functions and a master vehicle digital twin model to facilitate a central digital twin at a server.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

With respect to discussion of digital twin technology, various terminology may be used, including ‘physical entity’, which may refer to a real-world, tangible object or system that is being replicated digitally and can be anything from a manufacturing machine to an entire smart city. Other terminology may include ‘digital model’, which may refer to a virtual model that mirrors or mimics a physical entity and that may use data from sensors, IoT devices, and other data sources corresponding to the physical entity to represent the physical entity's structure or behavior. A ‘data connection’ may facilitate at least one real-time data flow, comprising data collected by, or generated by, sensors or Internet of Things (“IoT”) technology, between at least one physical entity and a corresponding digital twin that mirrors/mimics the at least one physical entity, thus enabling real-time monitoring and analysis of data corresponding to the at least one physical entity using the at least one digital twin model. A digital twin model may use advanced analytics, machine learning (“ML”), or artificial intelligence (“AI”) to process incoming data received according to a data connection. A digital twin model may be able to simulate various scenarios, predict outcomes, and provide insights for decision-making with respect to at least one physical entity to which the digital twin model corresponds. A prediction, simulated outcome, or other insight generated by a digital twin model may be referred to as an output of the digital twin model.

Digital twin technology may facilitate numerous applications and benefits with respect to different technology or industry sectors. With respect to manufacturing, digital twin technology may be used to optimize production processes, to improve product quality, or to reduce downtime of a physical entity based on predictive maintenance with respect to the physical entity facilitated by a digital twin model corresponding to the physical entity. Digital twin technology may facilitate a manufacturer simulating production lines, identifying bottlenecks, or implementing improvements without disrupting operations. With respect to healthcare, a patient-specific digital twin model may facilitate determining a personalized treatment plan prediction corresponding to disease progression. Digital twin technology may also facilitate development and testing of medical devices or pharmaceutical products. With respect to urban planning, digital twin technology may facilitate smart urban planning, infrastructure management, or sustainability initiatives. By simulating traffic patterns, energy usage, and environmental impacts, city planners can use information generated by a digital twin model to make informed decisions that may enhance urban living. With respect to the energy sector, digital twin technology may facilitate optimizing performance of power plants, grids, or renewable energy sources and may help in predicting equipment failures, optimizing maintenance schedules, or improving energy efficiency. Digital twin technology may facilitate autonomous operation of vehicles. A central digital twin model may interact with distributed digital twin models being executed by computing systems at one or more vehicles that may be operating as a cluster of vehicles or at least one entity functionality (e.g., vehicle prediction of a road condition, a hazard condition, a weather condition, a traffic condition, a wireless connectivity performance condition, or other condition). The vehicle functionality may be distributed amongst computing systems, corresponding to the cluster of vehicles, that may determine amongst themselves a leader computing system that may manage analysis of outcomes generated by digital twins corresponding to the at least one distributed functionality.

However, adoption of and use of digital twin technology faces several challenges. Integrating diverse data sources that may produce data or information in various formats or sizes, or at various periods or intervals, and presenting data to a digital twin model accurately and consistently is complex. Developing and maintaining digital twin models for large-scale systems, such as smart cities, may require significant computational resources and sophisticated algorithms. Protecting sensitive data and ensuring cybersecurity in interconnected digital twin systems are desirable goals.

Advancements in IoT, AI, and cloud computing are expected to further enhance the capabilities and adoption of digital twin technology, and as AI, IoT, and cloud computing technology evolves, digital twin models may become more sophisticated, providing deeper insights with respect to physical entities and facilitating proactive and efficient management of physical systems/entities.

In a wireless communication context, AI and ML (AI and ML may be collectively referred to as “AI/ML”), may facilitate cellular and backhaul embodiments that offer a wide set of performance and operational advantages such as network automation, signaling overhead reduction, energy saving, and capacity enhancement. The virtual nature of DT models can effectively simulate, or emulate, behavior of a physical entity or component thereof, or an entire physical system, thus facilitating proactive design optimizations, proactive fault detection, and predictive maintenance. However, implementing a complex DT by a central computing system, for example a computing system implemented by a computing system that is responsible for managing and processing data with respect to multiple physical entities, may require very robust processing and computing capabilities. For a DT to realistically and accurately reflect or predict behavior of a physical entity/system, the DT must be well-designed with modeled conditions being almost-identical to conditions corresponding to the real/physical entity/system. Thus, the larger and more diverse a DT model (e.g., the DT is designed to mimic/mirror multiple entities, multiple interfaces, etc.), the more complex the respective DT model becomes. Such complexity accordingly may result in a DT requiring a significant amount of signaling overhead for data collection (e.g., more communication resources may be needed to deliver data via a data connection for a complex DT as compared to resource needed to delivered data with respect to a more simple DT) with respect to each physical entity, system, or interface, to report back real-time condition information to an entity (e.g., a computing server system) that may be facilitating execution of the DT that may be central with respect to multiple entities being modeled by the DT. Moreover, a single, complex, central DT may require significant processing capability to facilitate high-performance modeling of an entire physical system, and such processing capability may be challenging to satisfy by processing capability available at a central computing system that may be facilitating operation of a complex, central DT.

To solve problems related to processing and computing capability corresponding to a central computing system, configured to execute a complex central DT model, being overwhelmed facilitating of the complex ventral DT mode, DT functionality outcome(s) may be determined by distributed, or federated, DT models located remotely with respect to the central computing system, wherein, instead of a single, central, complex DT model being implemented by the central computing system, one or more DT functions corresponding to the complex DT model may be delegated and distributed to computing systems associated with multiple entities, which may be referred to as distributed entities or delegated entities, wherein each delegated/distributed entity may execute a smaller/lighter and less complex DT as compared to a single, central, complex DT. Distributing DT functionality outcome determination from being executed by a complex central model/DT node to being executed by one or more computing systems corresponding to distributed entities may facilitate a central computing system implementing a simpler central model, operating in an energy-efficient or processing-efficient manner as compared to operation of a single complex DT model. A multi-node DT implementation that models multiple physical entities and that facilitates sharing of local DT intelligence and outcomes among multiple collaborating nodes may increase performance of DT modeling as compared to performance of a single/central complex DT model that attempts to model all of the multiple physical entities. However, both cellular/radio (e.g., 5G and higher) and backhaul communication interface links may need to be optimized to facilitate higher performance communication of DT information from remote distributed DT models to and from a central DT model. To facilitate communication of DT information associated with distributed DT models, regardless of the actual DT design and implementation (e.g., disregarding design of each local DT), embodiments disclosed herein may facilitate sharing of DT data and information wherein multiple distributed nodes (e.g., multiple distributed DT models respectively corresponding to multiple distributed physical entities), each executing a local, low-complexity DT, may share in unified signaling and communication to and from a central computing system that may be executing a simpler central DT. Outcomes and information generated by distributed DT models may be delivered to a central DT model without the central DT needing to consume processing resources to determine the information generated by the distributed DT model(s).

For example, in a backhaul computing example embodiment, a backhaul master server may collect and aggregate DT outcome information (e.g., predictions, system states, next-hop link states, etc.) determined by slave servers with respect to a link set corresponding to the backhaul system. Thus, according to the example embodiment, the master server may aggregate intelligence/information received from at least one distributed DT model corresponding to at least one distributed physical entity to facilitate performing proactive load balancing, proactive communication link routing (e.g., route changes), etc. without the need for constant availability of high-processing capability at the master server because per-server, per-hop information has been determined locally by the at least one distributed DT.

In another context, embodiments disclosed herein may be applied to optimize performance and energy efficiency of client devices, such as laptops, desktops, and other computing resources, by implementing distributed DTs that share intelligence about usage patterns, workload capacity, thermal management, and power consumption. Therefore, according to embodiments disclosed herein, a unified inter-node DT sharing procedure, including DT capability exchange, novel DT class definition communicating thereof, and DT intelligence reporting, may facilitate multi-vendor unified DT coordination, (e.g., coordination between a computing system server manufactured by a first manufacturer and a computing system server manufactured by a second manufacturer). Signaling procedures and DT class definitions according to embodiments disclosed herein may be designed to be vendor-agnostic, thus facilitating compatibility and interoperability across different hardware platforms and manufacturers.

According to example embodiments disclosed herein, DT classes may be defined that correspond to, or are indicative of, a DT function. DT node outcomes based on parameter metrics (e.g., measured values) corresponding to parameters associated with, or determined with respect to, physical entities may be requested by a computing system associated with a central digital twin model node and may be reported to the central node by one or more distributed digital twin model node(s). One or more digital twin model outcome(s) may be determined locally by one or more distributed DT nodes based on parameter value metrics, measured at distributed entities corresponding to the nodes, and may be reported to the computing system associated with the central digital twin model, thus reducing the need for the central DT model node to determine the outcomes corresponding to the distributed entities.

### Inter-Node Digital Twin Collaboration

In an example, a distributed computing ecosystem may comprise edge AI computing devices, for example personal computers (“PC”), high-performance servers, and storage nodes that may cooperate to facilitate inter-node DT collaboration as disclosed herein. Each computing system or device (e.g., each of a server, a storage device, or a PC may be configured to execute a DT model and may be referred to as a node) may execute respective local DT model corresponding to specific classes, such as, for example, “resource utilization,” “workload prediction,” and “energy optimization.” An edge AI-enabled PC may receive a request to perform an operation that may require, or invoked operation of, a compute-intensive AI workload. A DT model at the edge PC, operating at a high confidence level (typically>99.9%), may predict a resource deficit of 32 GB RAM and 8 TFLOPS of compute power. The edge PC may broadcast a capability request to the master server DT node via a low-latency (e.g., <5 ms) control channel resource. The master server DT node may send a request to pre-determined nodes to determine whether pre-determined nodes can accept, or ‘take on’ new AI workloads based on specified characteristics indicated by the edge PC. Responsive to the request sent by the mater sever DT node, one or more nodes, which may be facilitated by PC devices or other server devices, may activate a “resource availability” DT class or a “workload optimization” DT class. The nodes may report real-time predictions with respect to computing resource capability according to a high confidence level criterion to avoid the requesting mater server receiving non-useful DT outcome responses from low-confidence nodes. For example, the master server can ask all available remote nodes (e.g., remote with respect to the master server computing system) to determine that the remote node models are operating at >95% confidence level before accepting the request from the master server. The AI PC DT models may, collaboratively, aggregate information regarding computing resources and determine that a particular sever, other than the master server, having a 20-minute resource availability window is optimal target server to facilitate the workload with respect to the requesting edge PC. The DT nodes orchestrate a ‘just-in-time’ workload transfer that may be dynamically adjusted based on real-time, or near-real-time, updated information corresponding to the availability of computing resources. Such distributed determining of a DT outcome (e.g., determining a server that can facilitate a workload) may reduce latency and energy efficiency as compared to relying on a complex DT being executed by the master server to determine the DT outcome. Continuing with the example, post-processing (e.g., post-transfer of the workload to a determined server that can facilitate the workload) the workload may be repatriated to, or returned for execution by, edge PC that requested assistance in facilitating the workload, using a DT predicted transfer, further optimizing resource utilization across a computing network that comprises the edge PC, the master server, and the other servers that may facilitate the workload. Thus, improvements with respect to overall system efficiency, a reduction in operational costs, and an increase in workload throughput may be realized. Interoperability enabled by standardized indication of DT classes may facilitate vendor-agnostic optimization.

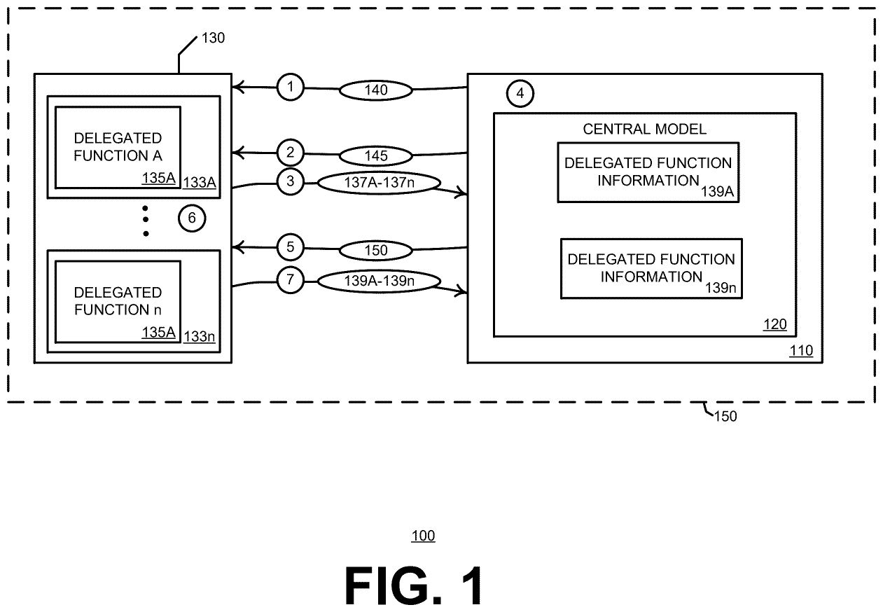

Turning now to FIG. 1, at act 1 first computing system 110 may direct, to second computing system 130, distributed entity model configuration information 140. Distributed entity model configuration information may comprise at least one distributed entity model function indication indicative of at least one distributed entity model function 135 to be implemented by second computing system 130. Second computing system 130 may be referred to as a distributed entity insofar as the second computing system may comprise at least one computer component, circuit, device, or other computer hardware that may be distinct from first computing system 110.

In an example embodiment, first computing system 110 and second computing system 130 may be different, or distinct, computing systems that are physically, or geographically, separated, or remotely located with respect to one another. For example, first computing system 110 may correspond to a first entity and may comprise a central computing server located at, or being executed by components located at, at least one computing data center that may be communicatively coupled to a communication network, for example the Internet. Second computing system 130 may correspond to at least one second entity and may comprise computing equipment that may comprise a computing server, computer devices such as laptops, smartphones. Second computing system 130 may comprise computer modules located in vehicles entities such as automobiles, boats, airplanes, space vehicles, satellites, or other movable objects that may facilitation operation of the vehicle or other movable object. Second computing system 130 may comprise computing equipment located at at least one building entity such as, for example, a residence home or apartment building, an office building, a retail building, a warehouse, a manufacturing facility, an industrial process facility, an electrical power plant, and the like. First computing system 110 may be referred to as a master computing system and second computing system 130 may be referred to as a slave computing system. First computing system 110 may be referred to as a central computing system and second computing system 130 may be referred to as a distributed computing system and an entity (e.g., a vehicle or a building) that is associated with the distributed computing system may be referred to as a distributed entity. First computing system 110, or model 120 corresponding thereto, may be referred to as a central model node and second computing system 130, or at least one distributed function model corresponding thereto, may be referred to as a distributed model node.

In an example embodiment, first computing system 110 and a second computing system 130 may be part of the same computing system 150 as shown by the broken lines in FIG. 1. For example, computing system 150 may be a laptop computer, a smartphone, a tablet, or other computing device that may comprise multiple components that may perform different functionality and that may communicate with each other via a communication data bus or via other communication links within system 150.

First computing system may facilitate execution of central model 120, which may be an artificial intelligence model. Central model 120 may comprise a digital twin model that corresponds to second computing system 130, and that may be used by computing system 110 to analyze information or data corresponding to second computing system 130 to control, operate, optimize operation of, predict operation of, or otherwise interact with the second computing system, or a second entity corresponding thereto (e.g., second computing system 130 may may be used to control or operate a second entity, such as, for example, a vehicle or mechanical system located at a factory building). First computing system 110 may execute central model 120 to analyze, with respect to second computing system 130 or with respect to at least one entity corresponding thereto, at least one parameter value with respect to at least one function (e.g., the central model may analyze a temperature value, a pressure value, an electrical characteristic value, or other measured metric corresponding to at least one parameter, to facilitate determining an model output that may be used to facilitate operation corresponding to, or that may be used to generate a prediction corresponding to, the at least one entity corresponding to the second computing system).

First computing system 110 may determine to delegate analysis with respect to at least one function 135 to distributed computing system 130. Accordingly, configuration information 140 may comprise at least one parameter indication indicative of at least one parameter associated with at least one distributed entity model function 135 to be performed by distributed computing system 130. Distributed computing system 130 may perform at least one indicated distributed entity model function 135 according to at least one respectively corresponding distributed digital twin model 133.

Distributed entity model configuration information 140 may further comprise at least one reporting criterion associated with at least one distributed entity model function 135 to be usable by the at least one distributed entity 130 to determine to transmit, direct, or otherwise communicate, at least one available capability indication indicative of at least one available capability to determine, by the distributed entity/computing system according to at least one distributed entity model 133, at least one output, or result, of analyzing at least one metric/measured value corresponding to at least one parameter associated with at least one distributed entity model function 135.

At act 2, central computing system 120 may transmit, or direct, to at least one distributed entity 130, corresponding to at least one distributed entity model 133, at least one available capability request 145. Capability request 145, which may be referred to as an available model/function class request, or simply an available function class request, may indicate a request for entity/system 130 to report back to central computing system 110 at least one indication indicative of at least one parameter or at least function indicated by configuration information 140 that entity/system 130 can perform. At act 3, responsive to the at least one available model/function class request 145, entity/system 130 may transmit/direct to central system 110, and the central system may receive, at least one available model function class indication 137 indicative of at least one available model/function class output, determined by entity/system 130, that entity/system 130 is capable of determining, generating, or otherwise providing to system 110 according to at least one digital twin model that may be executed by entity/system 130.

At act 4, entity system/node 110 may determine to delegate to entity system 130 at least one digital twin/model function 135, indicated by indication 137, that may otherwise be performed by central model 120 if not delegated to system 130. The at least one function 135, or parameter, determined by entity system 110 determined at act 4 may be based on the at least one available capability indication 137 and may be referred to as at least one delegated function. By delegating determining, or performing, of at least one delegated function 135, or analyzing a parameter corresponding thereto, to entity/system 130, computing processing load experienced by entity/system 110 that may execute central model 120 may be reduced by distributed entity/system 130 performing computing processing to determine a digital twin output corresponding to a delegated parameter or function. At act 5, entity system 110 may direct, or transmit, or otherwise communicate to entity system 130 at least one delegated function request 150, or indication, indicative of at least one delegated function 135, to the at least one distributed entity system 130.

At act 6, distributed entity system 130 may determine delegated function information/model output information 139 corresponding to at least one delegated function 135 indicated by request 150 and may at act 6 report the determined delegated function information/output to entity system 110. The determining or reporting of delegated function information 139 may be based on criterion indicated in configuration information 140. Responsive to the at least one delegated function indication/request 150, central entity/system 130 may receive, from at least one distributed entity/system 120, delegated function information 139 corresponding to the at least one delegated function 135. Based on delegated function information 139, central model 120, or entity system 110, may activate, optimize, control or otherwise perform an operation with respect to an entity associated with system 130 or associated with a computing resource corresponding thereto.

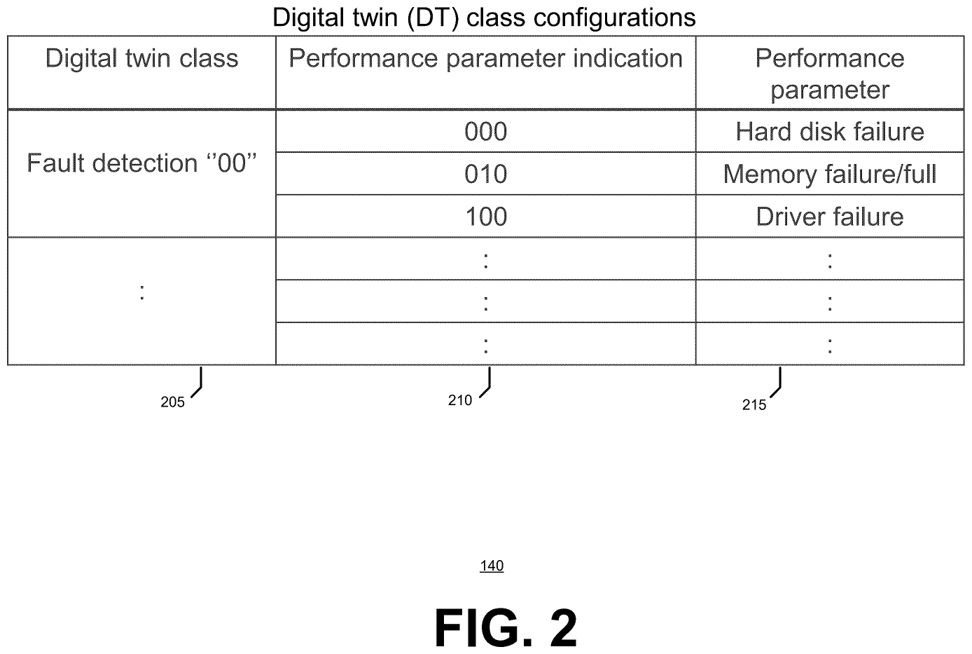

In an example embodiment, master processing system 110 may comprise a wireless communication Radio Access Network (“RAN”) node, a wireless transmit-receive unit (“WTRU”) (e.g., a smartphone in communication with the RAN node), a backhaul server computing system, or a computing function entity. System 110 may compile and direct/transmit/broadcast, single-cast, or multicast digital twin configuration 140, which may comprise DT class information, toward at least one slave processing unit 130 via a radio communication interface link, via a backhaul communication link, via am inter-WTRU sidelink wireless communication interface link, via a data bus, via a long range wireless link, or via another communication means. Information 140 may be directed to system 130 via a downlink-common control channel and/or at least one non-wireless interface. As shown in FIG. 2, information 140 may comprise in column 205 at least one DT class indication indicative of at least one DT class. Examples of DT classes may comprise at least one of: at least one energy efficiency class; at least one load/utilization class; at least one fault detection class; at least one on-board capability class; at least one radio link class, or other DT information class. Configuration information 140 may respectively comprise in column 210, for each DT class indicated in column 205, at least one performance parameter used by central model 120 to be emulated by at least one delegated DT function 135 that may be facilitated by at least one distributed entity system 130. Standardized configuration information 140 may facilitate smooth interoperability among multi-vendor equipment (e.g., a server computing system 110 may configure a distributed entity system 130 to determine parameters indicated in column 215 shown in FIG. 2 based on standardized parameter indications indicated in column 210.

Thus, regardless of a manufacturer or vendor of a computing system 110 or 130, or regardless of how the local DT models that may implement delegated function 137 may be designed or implemented, collaborating nodes (e.g., system 110 or system 130) can indicate available DT classes and performance metric parameters corresponding thereto to be determined or processed by a local node (e.g., entity system 130). Information indicated in column 205 may correspond to one or more DT classes or DT class types, that each may be associated with a specific type. For example, an available DT usable to determine proactive link fault detection corresponding to a communication link between system 110 and 130 (e.g., a wireless communication link if system 110 comprises a RAN node and if system 130 comprises a uses equipment device such as, for example, a smartphone) may facilitate proactively anticipating/predicting a potential next-hop link failures. Performance parameter indications indicated in column 210 may correspond to at least one actual performance parameter metric to be calculated, predicted, emulated, or output by distributed entity/system 130 that may execute a delegated function 137. Function 137 may be used to facilitate determining a metric corresponding to a parameter indicated in column 215 that may respectively correspond to a performance parameter indication respectively indicated in column 210.

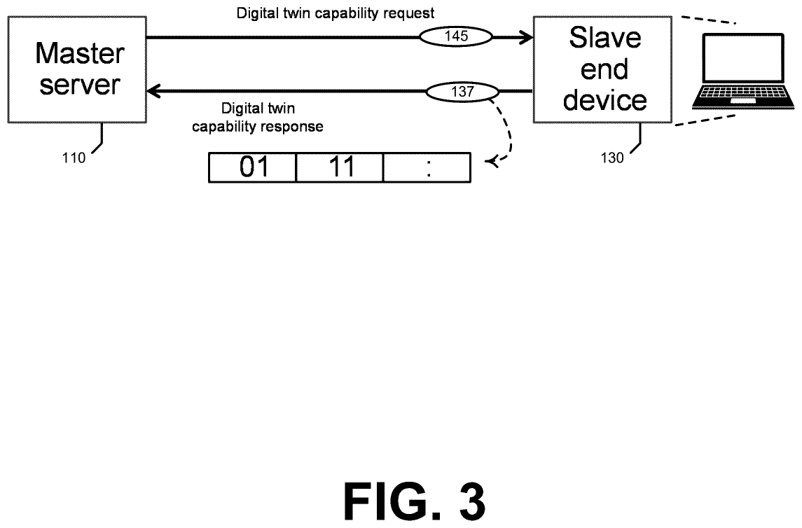

Turning now to FIG. 3, master processing unit/system 110 may transmit a digital twin capability request 145 toward at least one slave processing unit/system 130 via a communication link, for example a data bus, a backhaul link, or a wireless radio interface link, indicative of a request for slave node 130 to report back to system/node 110, via available model function class indication 137, at least one DT class that system 130 is capable of analyzing, calculating, determining, or otherwise processing. Reporting of available model function class indication 137 may facilitate coordination of nodes with different on-board DT capabilities. For example, a master node 110 (e.g., a server, user device, or other type of computing system) may experience degraded processing capability during a period due to, for example, low battery level, data processing overload, etc., and may temporarily relax supporting, or determining, by central DT model 120, shown in FIG. 1, information associated with at least one DT class. Accordingly, real-time DT capability corresponding to one or more distributed entity system(s) 130 may be indicated to central node system 110 and may be indicated to other distributed entity system(s) 130 that may be coordinating with central node 110.

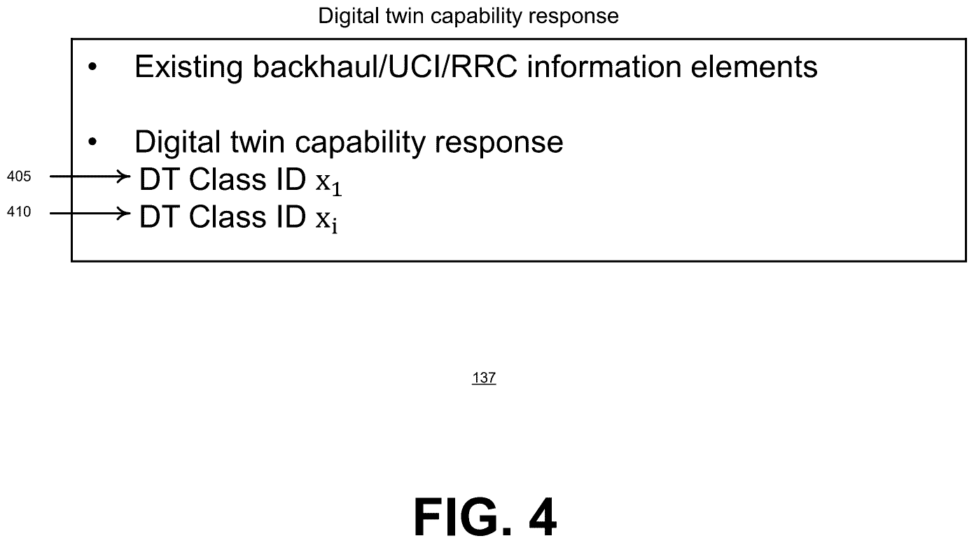

Master processing unit/system 110 may receive a DT capability response 137 from at least one distributed/slave unit/system, indicative of the at least one local DT class, as indicated by fields 405 and 410 in the sample illustrated by FIG. 4, available for local processing/determination by the at least one distributed slave unit/system. Response 137 may comprise at least one parameter indication selected from column 210 of configuration information 140 that may correspond to at least one parameter that the remote, distributed system 130 may be capable of determining.

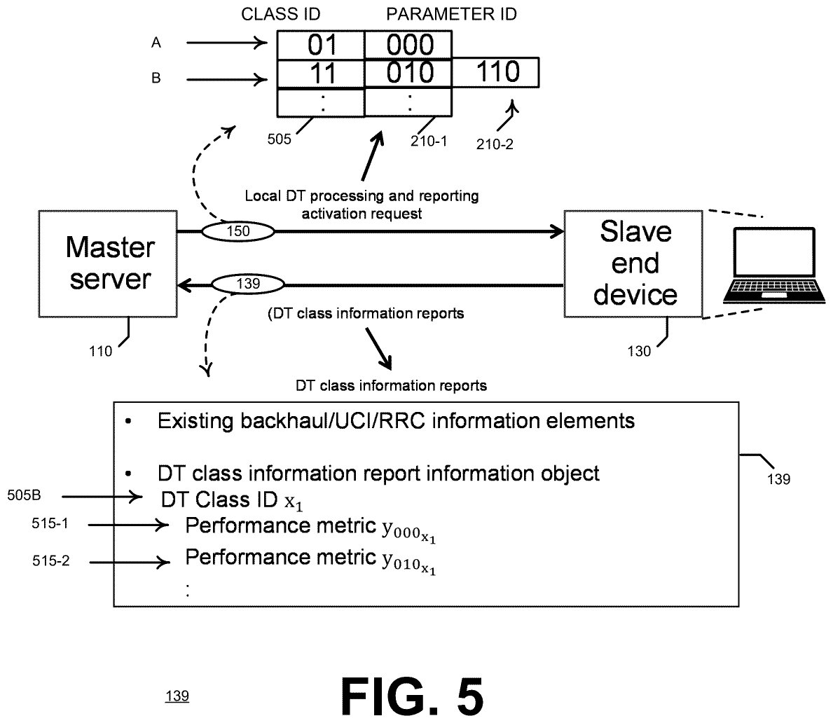

Turning now to FIG. 5, master processing system/unit 110 may direct/transmit a local DT processing and reporting activation request 150, shown in FIG. 1, toward at least one slave processing unit/system 130. Request 150 may comprise at least one DT class indication in field 505, indicative of at least one DT class to be activated, or corresponding DT information to be determined locally, by system/unit 130. In column 210-1-210-n, request 150 may comprise at least one corresponding performance parameter indication indicative of at least one performance parameter. A performance parameter may be indicative of at least one parameter corresponding to a DT class, with which the parameter(s) is/are associated in request 150, respectively associated with each DT class indicated in column 505. Request 150 may comprise at least one DT class reporting criteria that may indicate how or when system/unit 130 is to determine or report to master system/unit 110 measured performance parameter metrics corresponding to parameter indications indicated by field 210-1-210-n. In an example embodiment, reporting criterion may comprise, for example, an indication to report DT parameter metric information, requested via request 150, according to a configured periodicity. In an embodiment, reporting criterion may comprise, for example, DT confidence-triggered reporting wherein at least one determined DT performance parameter metric 139 may be reported by slave node 130 to master node 110 upon a minimum configured confidence level corresponding to a DT model facilitating executing a delegated function 135 being achieved or satisfied.

Master processing unit/system 110 may receive, from the at least one distributed/slave unit/system 130, DT class information 139 that may comprise, for each DT class indicated by request 150 in column 505, at least one real-time DT performance metric value/output corresponding to at least one performance parameter indicated by at least one field 210-1-210-n in request 150. For example, for a DT class corresponding to local utilization/load at a distributed entity/system/unit 130, report 139 may be indicative of a loading ratio increase of x % during a next-occurring hour. In another example, for a DT class, corresponding to fault detection indicated by request 150, an anticipated local hard disk failure, estimated or predicted by a distributed system 130 executing a distributed twin to determine a delegated function 135, may be indicated by a report 139 as being likely during an upcoming week. Accordingly, master system/unit/node 110 may receive DT information corresponding to a remote slave system/unit 130 and may use the received DT information to optimize operation of the remote distributed entity/system 130 without the master system 110 having to perform processing with respect to at least one delegated function 137 delegated to the remote distributed entity/system 130.

### Predictive Workload Orchestration in Edge-Cloud Environment

In an example embodiment, a distributed computing ecosystem may comprise edge AI personal computer (“PC”) nodes, high-performance server nodes, and storage equipment nodes. The example computing ecosystem may implement inter-node digital twin standardized protocol techniques disclosed herein and described in reference to FIGS. 1-5. Each node in the example ecosystem may execute local DTs corresponding to specific classes (e.g., specific delegated function), which may comprise, for example, a resource utilization function, a workload prediction function, or an energy optimization function.

An edge AI PC, which may be a master entity system 110 shown in FIG. 1, may receive a request for a compute-intensive AI workload. A DT 120, operating at the edge PC with 99.9% confidence level, may predict an available resource deficit of 32 GB RAM and 8 TFLOPS compute power (e.g., central DT may determine that system 110 may not have sufficient available computing resources to facilitate the requested workload). Accordingly, using techniques disclosed herein, system 110 may broadcast a capability request 145 via a low-latency (e.g., <5 ms) control channel resource, requesting that at least one distributed node/system 130 report available DT classes, or functions, that can be facilitated by DT models that may be executed by the distributed entity. At least one distributed entity 130 may respond to request 145 with at least one available model function class indication 137 indicative of at least one available model function class associated with system/node 130. System/node 110 may request, via request 150, that the at least one node/system 130 that responded to request 145 activate, or execute, a delegated function 135 that may have been indicated by the at least one indication 137. Responsive to request 150, nodes/systems 130 that responded to request 145 may activate delegated functions/delegated DT classes indicated by response indication 137 and may report real-time predictions 139 facilitated by at least one delegated DT class/function 135 with a high accuracy, thus relieving system/node 110 from consuming computing resources to perform the delegated DT class(es)/function(s). System/node 110 may determine predictions or other information with a high accuracy, for example a 95% accuracy. Central DT model 120 may aggregate information indicated by reported indications 139 and, based on reported information 139, may identify one or more auxiliary computing system(s), other than system 110, that may be able to facilitate the workload that system 110 may be unable to adequately facilitate. The determination of the auxiliary computing system may be based on a determination, by delegated function(s) 135, that the auxiliary system may have a twenty-minute resource availability window, which information regarding such twenty-minute availability may be indicated by at least one reported indication 139. Thus, delegating of DT functionality from master system 110 to at least one distributed system 130 may facilitate orchestration or scheduling a just-in-time workload transfer that may be dynamically adjusted based on sub-second updates 139, generated by delegated DT functions 135, received by central DT model 120 from distributed entities/systems 130. Accordingly, compared to relying on central model 120 that may be executed by a resource-starved computing system, using available resources corresponding to distributed entity computing system(s) 130 may result in improved energy efficiency and reduced latency with respect to workload transfer scheduling and workload placement.

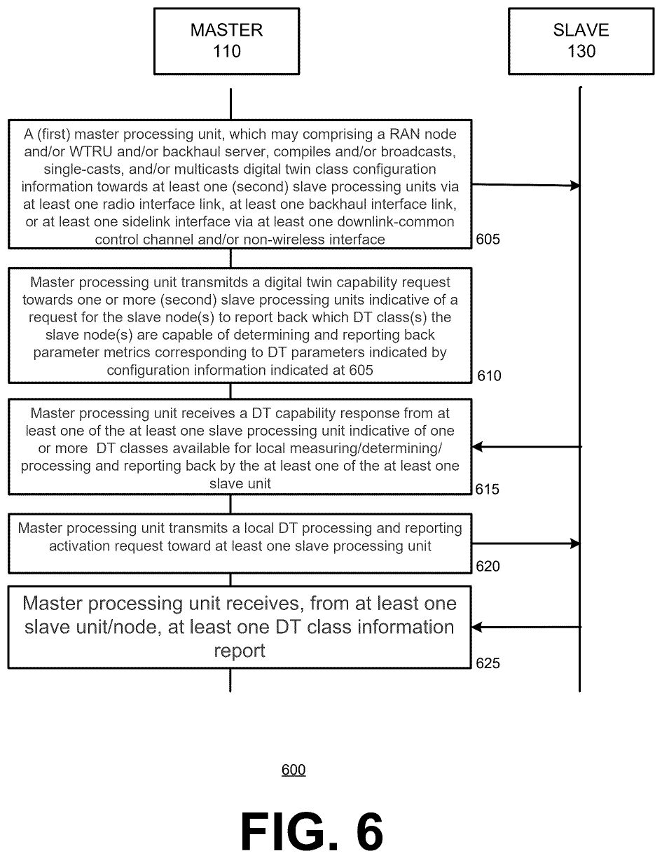

Turning now to FIG. 6, the figure illustrates a timing diagram of an example method to delegate digital twin model functions from a central model being facilitated by a master, or central, computing device 110, such as a computing server device, to at least one distributed digital twin model being facilitated by at least one distributed entity/system 135. At act 605, master system 110, which may comprise at least one of: a RAN node, a WTRU, or a backhaul computing server system, may compile and broadcast, single-cast, or multicast class configuration information 140 (described in reference to FIG. 1), toward at least one slave system 130 via a radio interface link, a backhaul interface link, a sidelink interface link, a downlink-common control channel, a wireless interface link, or a non-wireless interface link. Information 140 may comprise at least one DT class indication, for example as illustrated in column 205 of FIG. 2. A DT class indication may comprise, but may not be limited to, at least one energy efficiency class, at least one load/utilization class, at least one fault detection class, at least one on-board capability class, at least one radio link class, and other classes. For each of the available DT classes, information 140 may comprise, for example as shown in column 215 of FIG. 2, at least one performance parameter that may be processed or emulated by a DT model. Information 140 may comprise, in column 210, standardized parameter indications (e.g., numerical indication(s) respectively corresponding to parameters indicated in column 215).

At act 610, master system 110 may transmit a digital twin capability request (e.g., request 145 described in reference to FIG. 1) toward at least one slave system 130 via at least one communication link, for example, at least one radio interface link, at least one backhaul interface or at least one sidelink interface. The capability request may comprise a request that at least one system 130 indicate to system 110 at least one DT class that the at least on system 130 is capable of facilitating. At act 615, master processing unit 110 may receive, from at least one system 130, a DT capability response (e.g., system 110 may receive an indication 137 described in reference to FIG. 1), indicative of at least one available local DT class that the at least one system 110 is capable of facilitating. At act 620, master system 110 may transmit a local DT processing and reporting activation request (e.g., request 150 described in reference to FIG. 1) toward the at least one slave system 130 that is indicative of at least one DT class identifier/indication to be indicative to the at least one system 130 to locally activate and execute the at least one DT class, or at least one DT function corresponding to the at least one indicated DT class (e.g., the DT class identifier is indictive to system 130 to implement a delegated function 135 described in reference to FIG. 1). Request 150 may comprise at least one performance parameter indication corresponding to each activated DT class indicated by request 150. Request 150 may comprise at least one DT class reporting criteria that may be indicative of at least one periodicity or at least one DT confidence level to be used to determine, by the at least one system 130, to trigger reporting of determined DT output information (e.g., reporting of DT information 139 described in reference to FIG. 1). DT class reporting may be triggered according to a periodicity indicated by request 150 or according to system 130 determining a minimum predefined DT accuracy/confidence level, which may be configured via request 150, corresponding to a delegated DT function 135. At act 625, master system 110 may receive, from the at least one slave system 130, at least one DT class information report (e.g., report/indication 139), that may comprise, for each activated DT class executed or determined by the at least one system 130 in response to request 150, at least one real-time DT-determined performance parameter metric output (e.g., a DT output corresponding to a delegated function 135 based on a measured parameter metric 515 respectively corresponding to at least one performance parameter indicated by indication 210 described in reference to FIG. 5). For example, slave system 130 may indicate, via a report 139, at least one determined value determined by a delegated DT function (e.g., a determined value corresponding to a local utilization/load parameter, a determined loading ratio percentage increase predicted to occur during an upcoming period, or, for a DT fault detection class, a prediction that a local hard disk failure is expected to occur during an upcoming period).

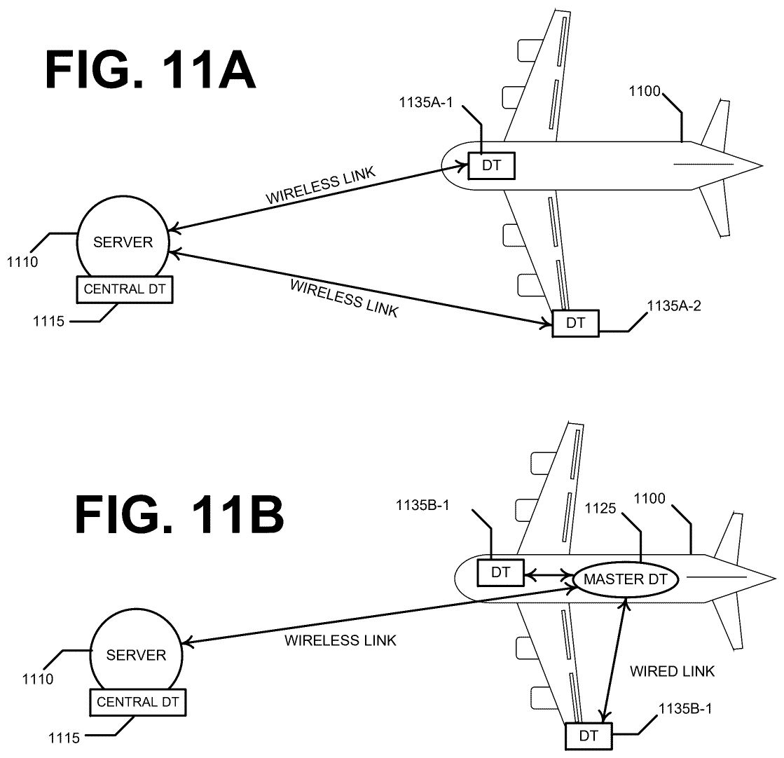

Turning now to FIG. 11A, the figure illustrates an example embodiment with airplane 1100 comprising distributed computing equipment to execute delegated digital twin function 1135A-1 corresponding to a fuselage-related function and delegated digital twin function 1135A-2. Distributed DTs 1135A may predict upcoming events based on data being collected according to a schedule, which may comprise periodic or continuous data collection, which scheduling may be based on a function with respect to which data is being collected. DTs 1135A may be trained by operation of physical entities to which they correspond (e.g., DT 1135A-1 may monitor fuselage-related data and DT 1135A-2 may monitor wing-related data). Instead of fuselage-related and wing-related data being directed to central DT 1115 being executed by server 1110, which may be located remotely with respect to distributed DTs 1135A, for processing by the central DT to determine a prediction based on the fuselage or wing data, DTs 1135A may process the fuselage-related data that corresponds to parameters indicated by a request 150, as described in reference to FIG. 1, and provide to central DT 1115 results, or outputs, determined by DTs 1135A, thus reducing processing load placed on central DT 1115 that would otherwise process fuselage or wing data to determine the results/outputs, which may comprise predictions, or information to be used in making predictions, based on fuselage or wing data. DTs 1135 may communicate determined results/outputs to remotely located server 1110 via wireless communication links. As shown in FIG. 11B, fuselage digital twin 1135B-1 and wing digital twin 1135B-2 may communicate, via wired communication links, DT outputs to a master digital twin 1125 being executed by a computing system located onboard airplane 1100 and the master digital twin may forward, or process and forward, results received from delegated digital twins 1135B to central digital twin 1115 via wireless communication links.

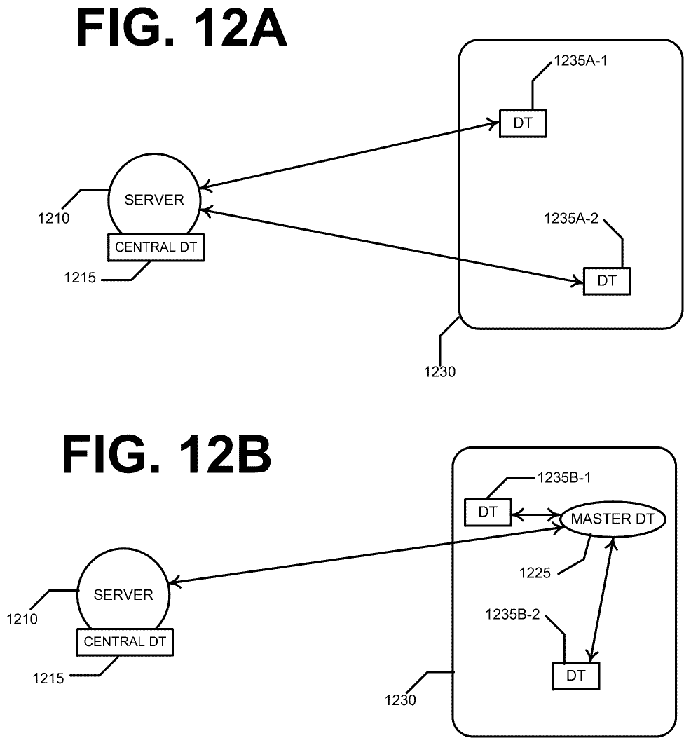

In another example embodiment shown in FIG. 12A, a computing device 1230, for example a smartphone, a laptop, a tablet, or similar device, may facilitate execution of distributed digital twins 1235A-1 and 1235A-2. Distributed digital twins 1235A may communicate via wireless communication links delegated function results to remotely located server 1210 for processing by central digital twin 1215 thus reducing processing loading on central digital twin 1215. In the example embodiment shown in FIG. 12B, distributed digital twins 1235 may determine outputs of delegated functions corresponding thereto and may provide the output information to master digital twin 1225 which may then process and direct outputs determined by distributed digital twins 1235B, or information determined based on the outputs, to remotely located server 1210 for further processing by central digital twin 1215 thus reducing processing loading on the central digital twin that may otherwise have been incurred if distributed entity digital twins 1235B were not used to perform processing, according to delegated functions corresponding to digital twins 1235B, of data generated by device 1230.

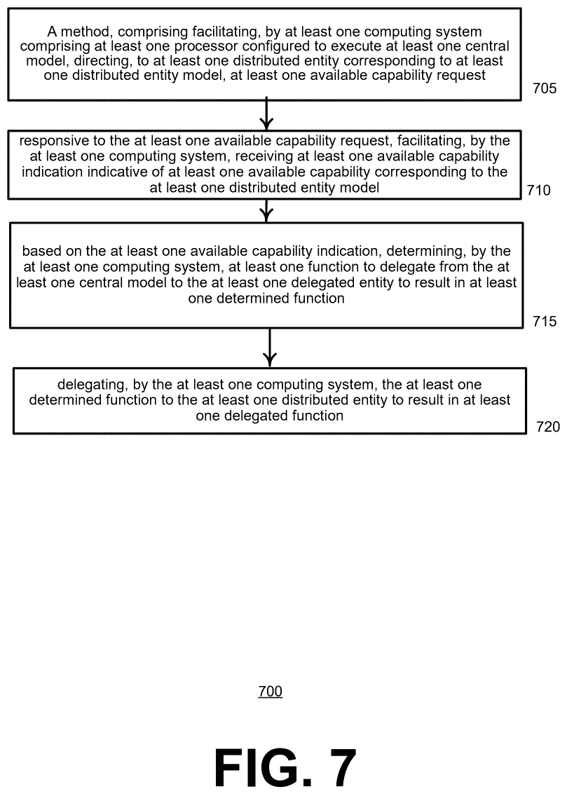

Turning now to FIG. 7, the figure illustrates an example embodiment method 700 comprising at block 705 facilitating, by at least one computing system comprising at least one processor configured to execute at least one central model, directing, to at least one distributed entity corresponding to at least one distributed entity model, at least one available capability request; at block 710, responsive to the at least one available capability request, facilitating, by the at least one computing system, receiving at least one available capability indication indicative of at least one available capability corresponding to the at least one distributed entity model; at block 715, based on the at least one available capability indication, determining, by the at least one computing system, at least one function to delegate from the at least one central model to the at least one delegated entity to result in at least one determined function; and at block 720 delegating, by the at least one computing system, the at least one determined function to the at least one distributed entity to result in at least one delegated function.

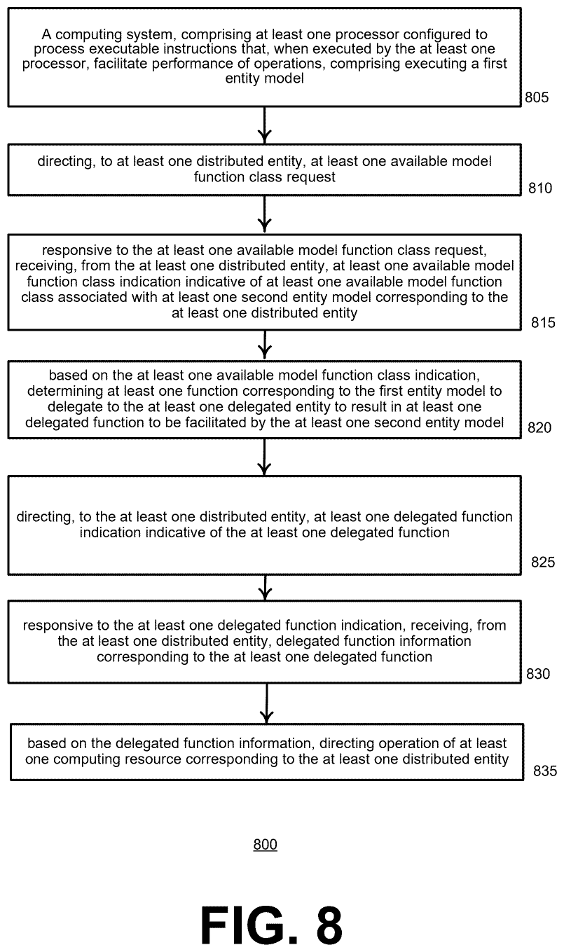

Turning now to FIG. 8, the figure illustrates an example computing system, comprising at block 805 at least one processor configured to process executable instructions that, when executed by the at least one processor, facilitate performance of operations, comprising executing a first entity model; at block 810 directing, to at least one distributed entity, at least one available model function class request; at block 815, responsive to the at least one available model function class request, receiving, from the at least one distributed entity, at least one available model function class indication indicative of at least one available model function class associated with at least one second entity model corresponding to the at least one distributed entity; at block 820, based on the at least one available model function class indication, determining at least one function corresponding to the first entity model to delegate to the at least one delegated entity to result in at least one delegated function to be facilitated by the at least one second entity model; at block 825 directing, to the at least one distributed entity, at least one delegated function indication indicative of the at least one delegated function; at block 830, responsive to the at least one delegated function indication, receiving, from the at least one distributed entity, delegated function information corresponding to the at least one delegated function; and at block 835, based on the delegated function information, directing operation of at least one computing resource corresponding to the at least one distributed entity.

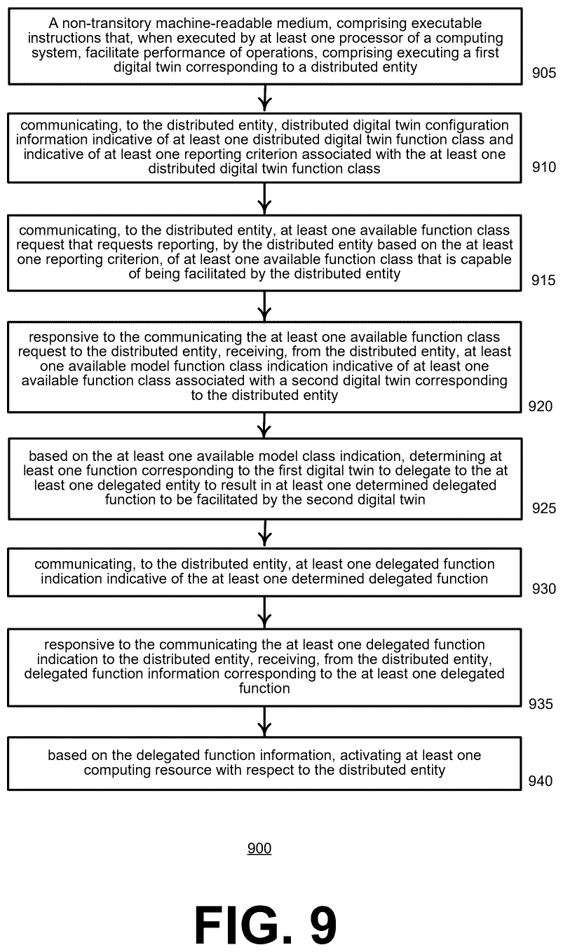

Turning now to FIG. 9, the figure illustrates a non-transitory machine-readable medium 900 comprising at block 905 executable instructions that, when executed by a processor of a computing system, facilitate performance of operations, comprising executing a first digital twin corresponding to a distributed entity; at block 910 communicating, to the distributed entity, distributed digital twin configuration information indicative of at least one distributed digital twin function class and indicative of at least one reporting criterion associated with the at least one distributed digital twin function class; at block 915 communicating, to the distributed entity, at least one available function class request that requests reporting, by the distributed entity based on the at least one reporting criterion, of at least one available function class that is capable of being facilitated by the distributed entity; at block 920, responsive to the communicating the at least one available function class request to the distributed entity, receiving, from the distributed entity, at least one available model function class indication indicative of at least one available function class associated with a second digital twin corresponding to the distributed entity; at block 925, based on the at least one available model class indication, determining at least one function corresponding to the first digital twin to delegate to the at least one delegated entity to result in at least one determined delegated function to be facilitated by the second digital twin; at block 930 communicating, to the distributed entity, at least one delegated function indication indicative of the at least one determined delegated function; at block 935, responsive to the communicating the at least one delegated function indication to the distributed entity, receiving, from the distributed entity, delegated function information corresponding to the at least one delegated function; and at block 940, based on the delegated function information, activating at least one computing resource with respect to the distributed entity.

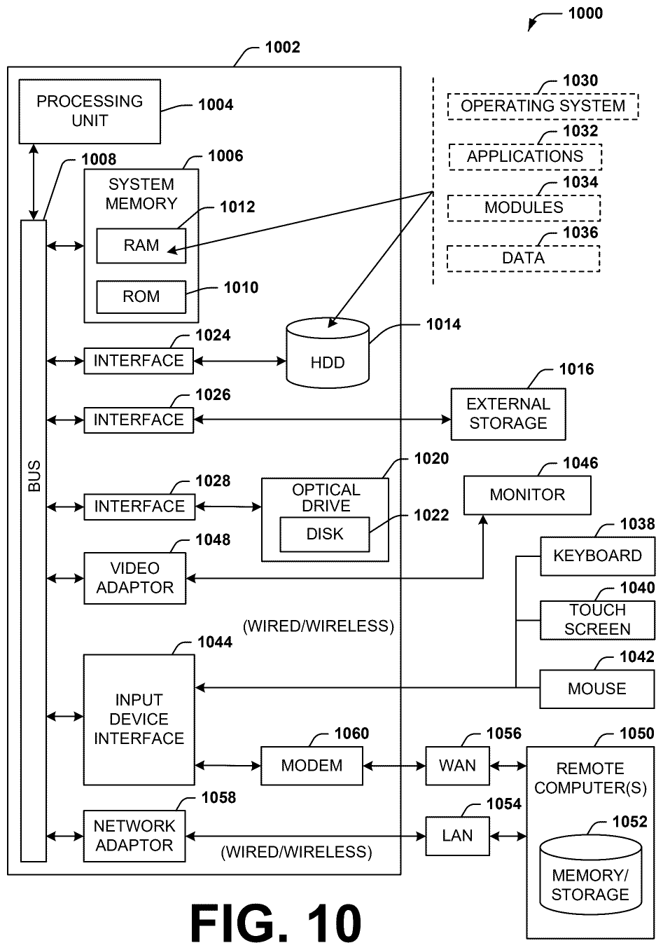

In order to provide additional context for various embodiments described herein, FIG. 10 and the following discussion are intended to provide a brief, general description of a suitable computing environment 1000 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

Computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1010. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art.

Furthermore, to the extent that the terms “includes,” “has,” “contains,” and other similar words are used in either the detailed description or the claims, such terms are intended to be inclusive in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by at least one computing system comprising at least one processor configured to execute at least one central model, directing, to at least one distributed entity corresponding to at least one distributed entity model, at least one available capability request;
responsive to the at least one available capability request, facilitating, by the at least one computing system, receiving at least one available capability indication indicative of at least one available capability corresponding to the at least one distributed entity model;
based on the at least one available capability indication, determining, by the at least one computing system, at least one function to delegate from the at least one central model to the at least one delegated entity to result in at least one determined function; and
delegating, by the at least one computing system, the at least one determined function to the at least one distributed entity to result in at least one delegated function.

2. The method of claim 1, wherein the at least one computing system comprises a first computing system executing the at least one central model, and wherein the at least one computing system comprises a second computing system configured to execute the at least one distributed entity model.

3. The method of claim 1, wherein the at least one computing system comprises a first computing system, and wherein a second computing system that is different than the first computing system is configured to execute the at least one distributed entity model.

4. The method of claim 3, wherein a radio network node corresponding to a radio access network comprises the first computing system, and wherein a user device, communicatively coupled with the radio network node, comprises the second computing system.

5. The method of claim 1, wherein the at least one available capability indication is indicative of at least one distributed entity model function corresponding to the at least one distributed entity model.

6. The method of claim 5, wherein the at least one delegated function is at least one of the at least one distributed entity model function.

7. The method of claim 5, wherein the at least one distributed entity model function comprises at least one of: at least one energy efficiency function, at least one load/utilization function, at least one fault detection function, at least one capability function indicative of at least one function associated with the at least one distributed entity, or at least one radio link function.

8. The method of claim 1, wherein the at least one central model comprises at least one central digital twin model.

9. The method of claim 8, wherein the at least one central digital twin model corresponds to the at least one distributed entity.

10. The method of claim 1, wherein the at least one distributed entity model comprises at least one distributed entity digital twin model.

11. The method of claim 1, further comprising:
facilitating, by the least one computing system, directing, to the at least one distributed entity, distributed entity model configuration information comprising at least one distributed entity model function to be implemented by the at least one distributed entity.

12. The method of claim 11, wherein the distributed entity model configuration information further comprises at least one parameter indication indicative of at least one parameter associated with the at least one distributed entity model function.

13. The method of claim 11, wherein the distributed entity model configuration information further comprises at least one reporting criterion associated with the at least one distributed entity model function to be usable by the at least one distributed entity to determine to direct, to the central model, the at least one available capability indication indicative of at least one available capability corresponding to the at least one distributed entity model.

14. The method of claim 13, wherein the at least one reporting criterion comprises a confidence level corresponding to an operation corresponding to the at least one distributed entity model function.

15. A computing system, comprising at least one processor configured to process executable instructions that, when executed by the at least one processor, facilitate performance of operations, comprising:
executing a first entity model;
directing, to at least one distributed entity, at least one available model function class request;
responsive to the at least one available model function class request, receiving, from the at least one distributed entity, at least one available model function class indication indicative of at least one available model function class associated with at least one second entity model corresponding to the at least one distributed entity;
based on the at least one available model function class indication, determining at least one function corresponding to the first entity model to delegate to the at least one delegated entity to result in at least one delegated function to be facilitated by the at least one second entity model;
directing, to the at least one distributed entity, at least one delegated function indication indicative of the at least one delegated function;
responsive to the at least one delegated function indication, receiving, from the at least one distributed entity, delegated function information corresponding to the at least one delegated function; and
based on the delegated function information, directing operation of at least one computing resource corresponding to the at least one distributed entity.

16. The computing system of claim 15, wherein the at least one computing resource comprises at least one of: at least one processing resource, at least one storage resource, at least one radio channel resource, at least one memory resource, at least one power supply resource corresponding to the at least one distributed entity, or at least one battery resource corresponding to the at least one distributed entity.

17. The computing system of claim 15, wherein the operations further comprise:
directing, to the at least one distributed entity, distributed entity model configuration information indicative of the at least one available model function class and indicative of at least one reporting criterion associated with the at least one model function class,
wherein the at least one available model function class indication is determined by the at least one distributed entity according to at least one distributed computing resource being determined to satisfy the at least one reporting criterion.

18. A non-transitory machine-readable medium, comprising executable instructions that, when executed by at least one processor of a computing system, facilitate performance of operations, comprising:
executing a first digital twin corresponding to a distributed entity;
communicating, to the distributed entity, distributed digital twin configuration information indicative of at least one distributed digital twin function class and indicative of at least one reporting criterion associated with the at least one distributed digital twin function class;
communicating, to the distributed entity, at least one available function class request that requests reporting, by the distributed entity based on the at least one reporting criterion, of at least one available function class that is capable of being facilitated by the distributed entity;
responsive to the communicating the at least one available function class request to the distributed entity, receiving, from the distributed entity, at least one available model function class indication indicative of at least one available function class associated with a second digital twin corresponding to the distributed entity;
based on the at least one available model class indication, determining at least one function corresponding to the first digital twin to delegate to the at least one delegated entity to result in at least one determined delegated function to be facilitated by the second digital twin;
communicating, to the distributed entity, at least one delegated function indication indicative of the at least one determined delegated function;
responsive to the communicating the at least one delegated function indication to the distributed entity, receiving, from the distributed entity, delegated function information corresponding to the at least one delegated function; and
based on the delegated function information, activating at least one computing resource with respect to the distributed entity.

19. The non-transitory machine-readable medium of claim 18, wherein the computing system comprises the distributed entity and the at least one computing resource.

20. The non-transitory machine-readable medium of claim 18, wherein the at least one available model function class indication is determined by the distributed entity according to the at least one reporting criterion.
